(19) United States
(12) Patent Application Publication
(10) Pub. No.: US 2005/0247560 A1
(43) Pub. Date: Nov. 10, 2005

(54) Gas sensor

(76) Inventors: Helmut Weyl, Schwieberdingen (DE); Juergen Wilde, Fellbach (DE); Andreas Pesch, Krefeld (DE)

Correspondence Address: KENYON & KENYON, ONE BROADWAY, NEW YORK, NY, 10004, US

(21) Appl. No.: 10/521,674

(22) PCT Filed: Jul. 4, 2003
(86) PCT No.: PCT/DE03/02242

§ 371 Date: Jan. 18, 2005

(30) Foreign Application Priority Data
Jul. 27, 2002 (DE) 102 34 266.0

(51) Int. Cl. G01N 27/26

(52) U.S. Cl. 204/424; 204/431

(57) ABSTRACT

A gas sensor for determining a physical property of a measuring gas, in particular for determining the temperature of the measuring gas or the concentration of a gas component of the measuring gas. The gas sensor has a sensor element, at least one contact surface situated on the sensor element, and a contact piece electrically connected to the contact surface. The contact piece is clamped in a friction-type manner between the contact surface and at least one press-on body which is clamped against the sensor element by a spring element. The spring element at least partially grips around the press-on body and has a groove.

### BACKGROUND INFORMATION

A gas sensor is described in European Patent No. EP 0 506 897 for example. The gas sensor has a sensor element including outside contact surfaces at one end which are electrically connected to contact pieces, via which, for example, the signal of the sensor element is guided out of a housing of the gas sensor. Using a spring element gripping around the sensor element, the contact pieces are clamped in a friction-type manner between the contact surface and a press-on body which is clamped against the sensor element by the spring element.

It is disadvantageous in such gas sensors that the spring element has a comparatively steep characteristic curve of spring so that, even through small manufacturing fluctuations, either the force exerted by the spring element is too small, resulting in a poor contact of the sensor element, or a contact element is damaged when the spring element is attached.

Furthermore, a gas sensor is described in German Patent Application No. DE 101 32 826, in the housing of which a sensor element is mounted having an oblong, stack-like design. Contact surfaces are provided on two opposing outside surfaces at one end of the sensor element. The contact surfaces are electrically connected via leads to measuring elements situated inside the sensor element. For contacting the sensor element, connecting leads are pressed onto the appropriate contact surfaces by two press-on bodies facing each other. A spring element is provided for this purpose which grips around the press-on bodies and presses them onto the connecting leads or the contact surfaces.

The spring element is designed as a spring ring in the form of an annular disk having areas of different radial width. The central recess of the spring element accommodates the two press-on bodies and the sensor element. The spring element has two tongue-shaped spring sections protruding inward and resting against the press-on bodies. The spring element's outer contour is circular.

For assembly, the spring element is slid over the two press-on bodies. Prior to assembly, i.e., in the unclamped state, the spring element is a flat annular disk. In the clamped state, i.e., after the spring element has been slid over the two press-on bodies, the two spring sections are bent out of the plane of the annular disk, thereby exerting the force on the press-on bodies necessary for contacting the sensor element. The spring sections are thus deformed in a direction which has an essential component parallel to the longitudinal axis of the sensor element.

It is disadvantageous in such a gas sensor that, due to the deformation of the spring sections, the spring element, in its clamped state, is exposed to great stresses in certain areas which may result in damage to the spring element. These great stresses occur in particular in the area of the spring element in which the spring sections come in contact with the ring-shaped base of the spring element. Due to the great stresses in these areas, the spring element has a comparatively steep characteristic curve of spring and thus a comparatively small spring excursion. Moreover, very small tolerances are to be observed during manufacture and assembly of the elements to avoid deformation of the spring sections in the inelastic area. In addition, an exact alignment of the spring element for assembly is difficult due to the spring element's circular outer contour.

### SUMMARY OF THE INVENTION

The gas sensor according to the present invention has the advantage over the related art that a spring element is provided which has a flat characteristic curve of spring and a large spring excursion, which is easily manufactured and assembled, and in which the risk of damage during assembly is small.

The spring element has a groove for this purpose. Locally occurring stress maxima are decreased by the groove, and the danger of overstressing the spring element is clearly reduced due to a flatter characteristic curve of spring.

The spring element advantageously has a spring section resting against the press-on body, the spring section, in the clamped state, being deformed in a direction which has an essential component parallel to the longitudinal axis of the sensor element, the groove being provided in the area of the spring section on the side of the spring element facing away from the press-on body.

The groove is advantageously situated centrally to the spring section and has an oblong, wedge-shaped design with a rounded end in the direction of the spring section; the distance between the two opposing sides of the groove decreases in the direction of the spring section. The locally occurring stress maxima are particularly effectively reduced through a groove having such a design.

Two spring sections diametrically opposing one another are provided in an advantageous embodiment of the present invention. The spring element advantageously has two symmetrical planes: the plane perpendicular to the connecting line of the two spring sections, and the plane which is formed by the connecting line of the two spring sections and by the longitudinal axis of the sensor element.

Simple alignment of the spring element during assembly is made possible by the fact that the outside of the spring element has a flat design in the area of the groove and that the spring element's flat area stands perpendicular on the axis defined by the two opposing spring sections. The groove is then situated centrally to the spring element's flat area, the alignment of the spring element thus being additionally simplified.

### BRIEF DESCRIPTION OF THE DRAWINGS

FIG. 1 shows a sectional view of a gas sensor according to the present invention.

FIGS. 2 and 3 schematically show contacting of the gas sensor according to the present invention.

FIG. 4 shows a top view of a spring element according to the present invention.

FIG. 5 shows the characteristic curves of spring for a spring element without a groove and for the spring element according to the present invention including a groove.

### DETAILED DESCRIPTION

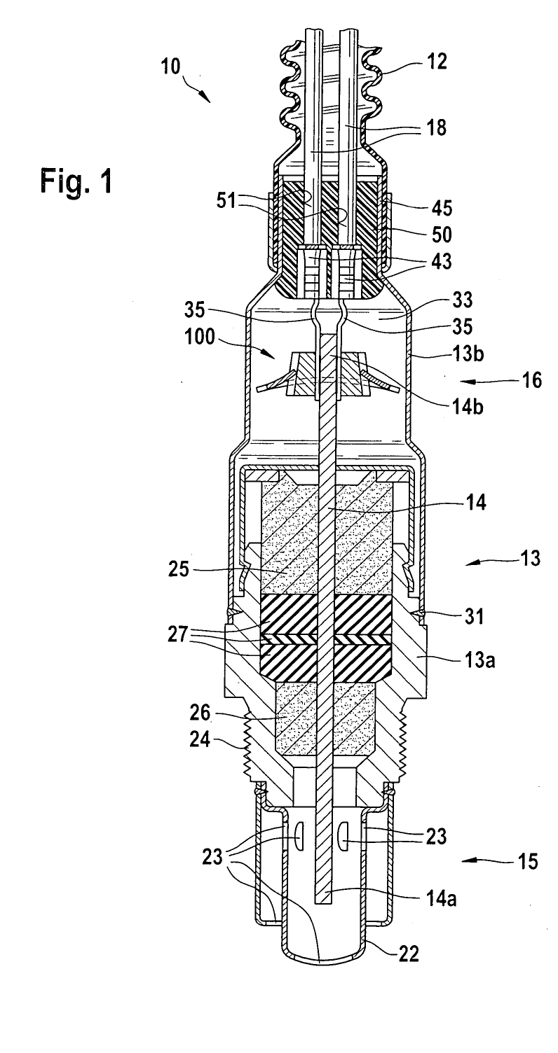

FIG. 1 shows a gas sensor 10, a lambda sensor or a broadband lambda sensor for example. Gas sensor 10 includes a measuring-side section 15 and a connecting-side section 16 and has a metallic housing 13 which is indicated in measuring-side section 15 using reference numeral 13a and in connecting-side section 16 using reference numeral 13b. A planar, oblong sensor element 14 is fixed in a gas-tight manner in housing 13 using ceramic moldings 25, 26 and a sealing element 27. In its connecting-side section 16, gas sensor 10 is connected to a cable jacket 12 in which connector cables 18 for sensor element 14 are routed.

A protective pipe 22 having gas inlet orifices and gas outlet orifices 23 is mounted on measuring-side section 13a of housing 13. Protective pipe 22 encloses a measuring-side end 14a of sensor element 14 which protrudes from measuring-side section 13a of housing 13. A thread 24, with which gas sensor 10 may be mounted in an exhaust pipe (not shown), is additionally attached to measuring-side section 15.

Connecting-side section 13b of housing 13 is mounted in a gas-tight manner on measuring-side section 13a of housing 13 using a radially circumferential welding seam 31.

Connecting-side section 13b of housing 13 encloses a connecting-side end 14b of sensor element 14 and forms an internal space 33 in which contacting 100 of sensor element 14 is provided (see FIG. 3) via which sensor element 14 is in electrical contact with contact pieces 35. The cable-side section of contact pieces 35 has a crimp connection 43. Contact pieces 35 are electrically connected to connector cables 18 via crimp connections 43.

Housing 13 has a tapering cylindrical connecting-side section 45 at end 13b. Cylindrical section 45 is closed by a cable duct 50. Cable duct 50 is made of PTFE, for example, and has routing holes 51 corresponding to the number of connector cables 18 to be routed.

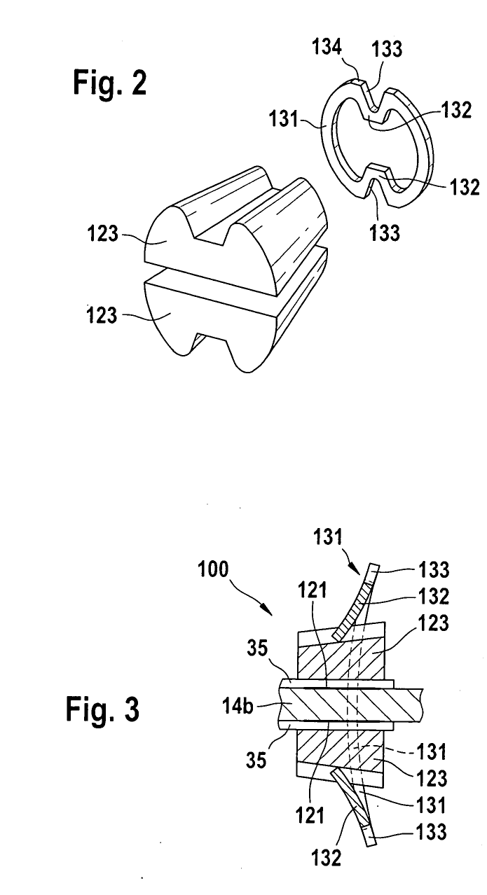

FIGS. 2 and 3 show contacting 100 of gas sensor 10. Contact surfaces 121 are provided on opposing sides of sensor element 14 in connecting-side section 14b of sensor element 14. Each contact surface 121 is electrically contacted with a contact piece 35 via contacting 100. Two press-on bodies 123 are provided for this purpose, connecting-side section 14b of sensor element 14 and contact pieces 35 being situated between them. Press-on bodies 123 are pressed together by a spring element 131, so that contact pieces 35 provided between press-on bodies 123 are pressed against contact surfaces 121 of senor element 14.

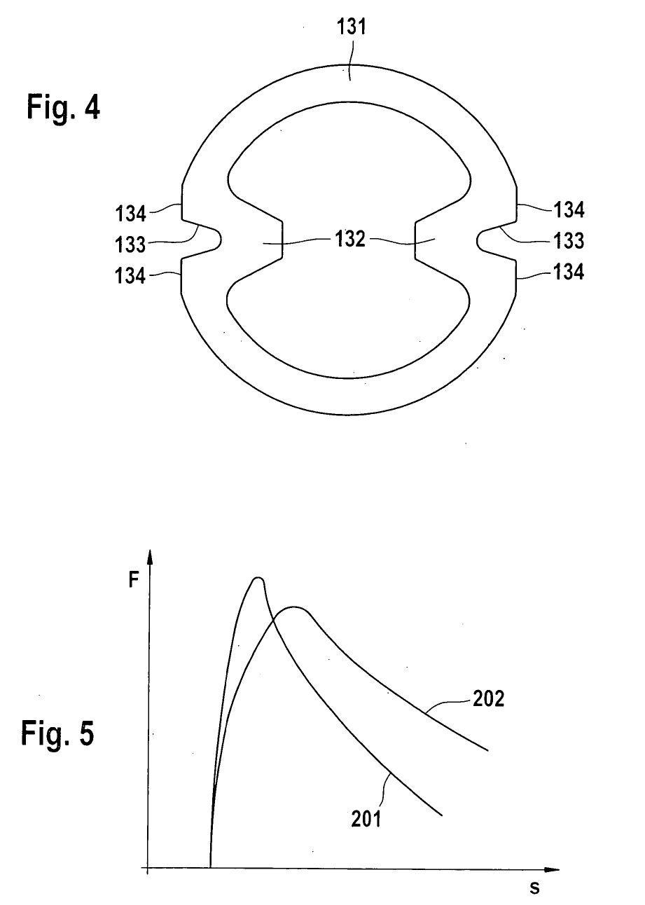

FIGS. 2 and 4 show spring element 131 prior to being slid and thus clamped onto press-on bodies 123. Prior to clamping, spring element 131 is a flat, annular stamping piece which has two opposing spring sections 132 protruding inward. One groove 133 is provided in the area of each spring section 132 on the outside of spring element 131. Spring element 131 is mirror-symmetrical with regard to the axis which connects both spring sections 132, as well as to the axis being perpendicular to this axis (through the center of spring element 131). Groove 133 is thus situated centrally to the particular spring section 132. Groove 133 has an oblong and wedge-shaped design with a rounded end in the direction of spring section 132. Outside 134 of the spring element is flattened in the areas of spring element 131 adjacent to groove 133. The straight line, defined by flat areas 134 on both sides of groove 133, stands perpendicular to the axis which is formed by the two opposing spring sections 132. Apart from spring sections 132, groove 133, and flat areas 134, the outside as well as the inside of spring element 131 have a circular design.

For contacting sensor element 14, spring element 131 is slid over both press-on bodies 123. Spring element 131 is in contact with press-on bodies 123 merely via spring sections 132. When sliding over press-on bodies 123, spring sections 132 of spring element 131 bend in a direction which has an essential component parallel to the longitudinal axis of sensor element 14 (see FIG. 3). FIG. 5 shows a characteristic curve of spring, i.e., force F exerted by spring element 131 as a function of deflection s of spring sections 132 of spring element 131. The curve labeled with reference numeral 201 indicates the characteristic curve of spring for a spring element without a groove; the curve labeled with reference numeral 202 is the characteristic curve of spring for a spring element 131 according to the present invention including groove 133. Spring element 131 including groove 133 has a considerably flatter characteristic curve of spring than the spring element without a groove.

1-14. (canceled)

15. A gas sensor for determining a physical property of a measuring gas, comprising:
a sensor element;
at least one press-on body;
a spring element clamping the press-on body against the sensor element, the spring at least partially gripping around the press-on body, the spring element having a groove;
at least one contact surface situated on the sensor element; and
a contact piece electrically connected to the contact surface, the contact piece being clamped in a friction-type manner between the contact surface and the at least one press-on body.

16. The gas sensor according to claim 15, wherein the gas sensor is for determining a temperature of the measuring gas.

17. The gas sensor according to claim 15, wherein the gas sensor is for determining a concentration of a gas component of the measuring gas.

18. The gas sensor according to claim 15, wherein the groove is situated in an area of the spring element in which the spring element rests against the press-on body.

19. The gas sensor according to claim 15, wherein the groove is situated on a side of the spring element facing away from the press-on body.

20. The gas sensor according to claim 15, wherein the spring element grips around the press-on body and has a spring section resting against the press-on body, in a clamped state the spring section being deformed in a direction which has an essential component parallel to a longitudinal axis of the sensor element.

21. The gas sensor according to claim 20, wherein, in an area of the spring section, the spring element has a groove on its side facing away from the press-on body.

22. The gas sensor according to claim 20, wherein the groove is situated centrally to the spring section.

23. The gas sensor according to claim 20, wherein the groove has at least one of an oblong and a wedge-shaped design with a rounded end in the direction of the spring section.

24. The gas sensor according to claim 20, wherein the spring section of the spring element is a radially inward oriented, tongue-shaped area.

25. The gas sensor according to claim 20, wherein the spring element has two spring sections substantially diametrically opposing one another.

26. The gas sensor according to claim 15, wherein the spring element is designed as a spring ring in the form of an annular disk having areas of different radial width.

27. The gas sensor according to claim 15, wherein, in an unclamped state, the spring element is a flat annular disk, and, in a clamped state, at least one spring section of the spring element is bent out of a plane of the annular disk.

28. The gas sensor according to claim 15, wherein an outside of the spring element has a flat design in areas adjacent to the groove, and the flat area of the spring element stands perpendicular to an axis defined by two opposing spring sections of the spring element.

29. The gas sensor according to claim 15, wherein the at least one press-on body includes at least two press-on bodies, and wherein the spring element clamps the at least two press-on bodies, substantially diametrically opposing one another relative to the sensor element, against the sensor element.

30. The gas sensor according to claim 15, wherein the spring element is in the form of a stamping piece.
